(19) United States
(12) Patent Application Publication
(10) Pub. No.: US 2015/0070601 A1
(43) Pub. Date: Mar. 12, 2015

(54) ELECTRONIC DEVICE

(71) Applicant: WINTEK CORPORATION, Taichung City (TW)

(72) Inventors: Ming-Chuan Lin, Taichung City (TW); Shih-Cheng Wang, Changhua County (TW); Tsung-Yi Lin, Taichung City (TW); Hui-Chien Chen, Changhua County (TW)

(21) Appl. No.: 14/477,850

(22) Filed: Sep. 4, 2014

(30) Foreign Application Priority Data
Sep. 6, 2013 (TW) 102132304

(51) Int. Cl. G02F 1/1333

(52) U.S. Cl. CPC G02F 1/13338
USPC 349/12

(57) ABSTRACT

An electronic device includes a first component, a second component and a combining unit. The first component is disposed correspondingly to the second component, and the combining unit is disposed between the first component and the second component so as to combine the first component with the second component. The combining unit includes a plurality of spacing structures. The spacing structures are used to define an accommodation space between the first component and the second component. Each of the spacing structures has a first end and a second end opposite to the first end. A width of the first end is wider than a width of the second end.

### BACKGROUND OF THE INVENTION

1. Field of the Invention

The present invention generally relates to an electronic device, and more particularly, to an electronic device including two components combined by a liquid optical clear adhesive.

2. Description of the Prior Art

In recent years, touch sensing technologies have developed flourishingly, and consumer electronics integrated with touch sensing function are commercialized accordingly. In those consumer electronics, display panels are mainly used to be integrated with the touch sensing function. In other words, the display panels are replaced by the touch display panels with the touch sensing function. According to differences in structure designs, the touch display panels may include an out-cell type touch display panel, an in-cell type touch display panel, and an on-cell type touch display panel. In the out-cell type touch display panel, an independent touch panel is attached to a normal display panel . A lamination process is required to combine an out-cell type touch panel and a display panel, combine an in-cell type touch display panel and a cover lens, or combine a cover lens and a normal touch panel.

Generally, solid-state optical clear adhesives are employed in the lamination process of the related industries. However, height differences on rugged surfaces of the modules to be bound are difficult to be filled with the solid-state optical clear adhesive. The appearance quality and electrical operations of the electronic device may be affected accordingly.

### SUMMARY OF THE INVENTION

It is one of the objectives of the present invention to provide an electronic device. A combining unit including spacing structures is used to combine two components so as to enhance lamination performances and process qualities.

To achieve the purposes described above, a preferred embodiment of the present invention provides an electronic device. The electronic device includes a first component, a second component and a combining unit. The second component is disposed correspondingly to the first component. The combining unit is disposed between the first component and the second component so as to combine the first component with the second component. The combining unit includes a plurality of spacing structures configured to define an accommodation space between the first component and the second component. Each of the spacing structures has a first end and a second end opposite to the first end. A width of the first end is wider than a width of the second end.

In the present invention, a liquid optical clear adhesive is used to form the combining unit for laminating two components in the electronic device. A filling performance of the combining unit may be improved and related qualities of the electronic device may be enhanced accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic flow chart illustrating a lamination method of an electronic device according to a first embodiment of the present invention.

FIG. 2, FIG. 3, FIG. 4 and FIG. 5 are schematic diagrams illustrating the lamination method of the electronic device according to the first embodiment of the present invention.

FIG. 6 is a schematic cross-sectional diagram taken along a line A-A′ in FIG. 5.

FIG. 7 is a schematic diagram illustrating an electronic device according to a second embodiment of the present invention.

FIG. 8 is a schematic diagram illustrating an electronic device according to a third embodiment of the present invention.

FIG. 9 is a schematic diagram illustrating an electronic device according to a fourth embodiment of the present invention.

FIG. 10 is a schematic diagram illustrating an electronic device according to a fifth embodiment of the present invention.

FIG. 11 is a schematic diagram illustrating an electronic device according to a sixth embodiment of the present invention.

FIG. 12 is a schematic diagram illustrating an electronic device according to a seventh embodiment of the present invention.

FIG. 13 is a schematic diagram illustrating an electronic device according to an eighth embodiment of the present invention.

FIG. 14 is a schematic diagram illustrating an electronic device according to a ninth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

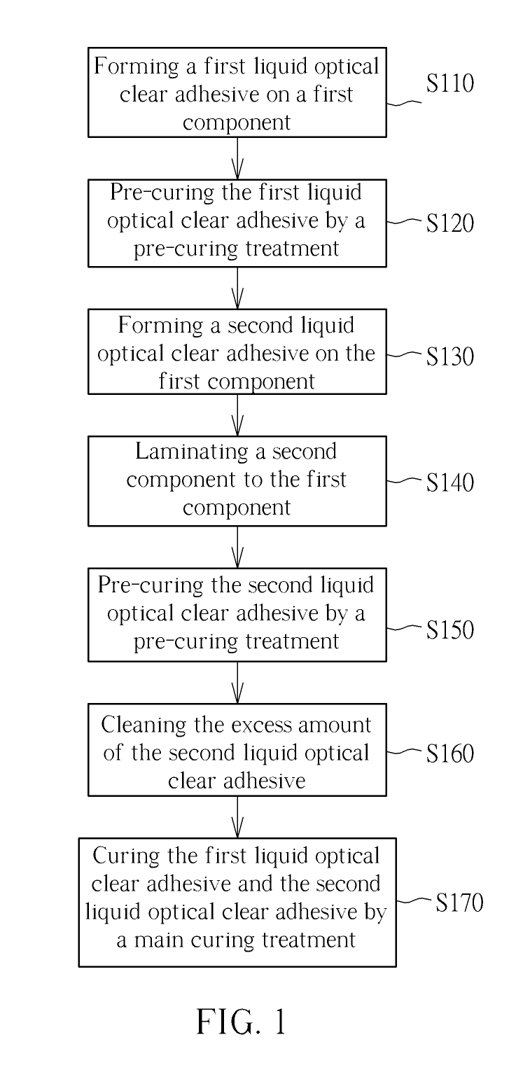

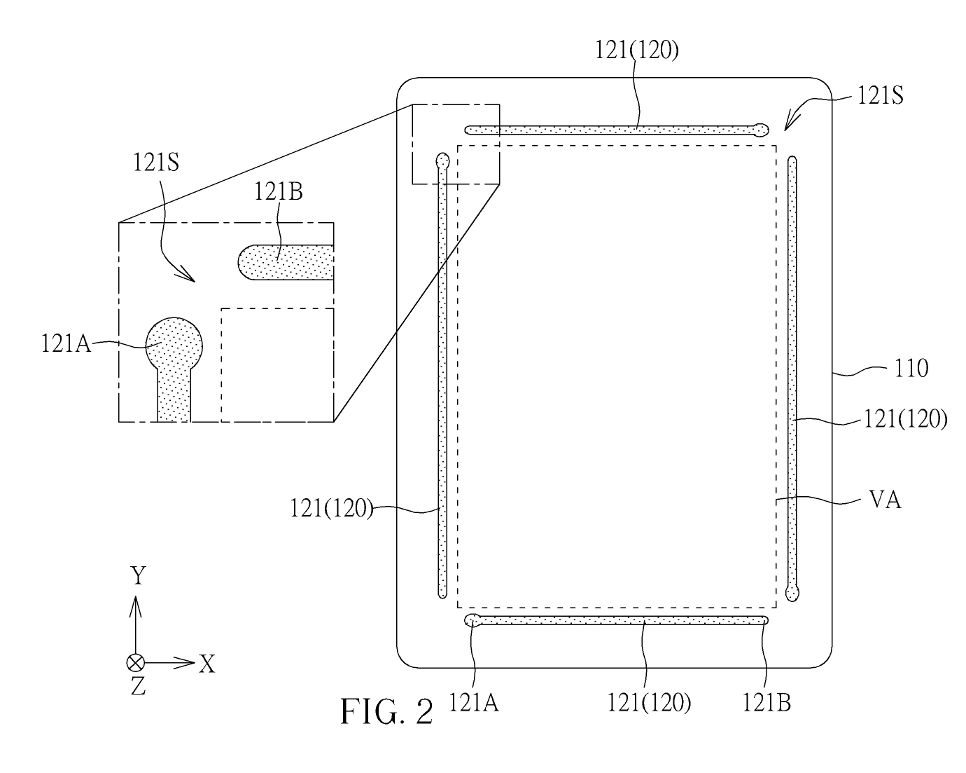

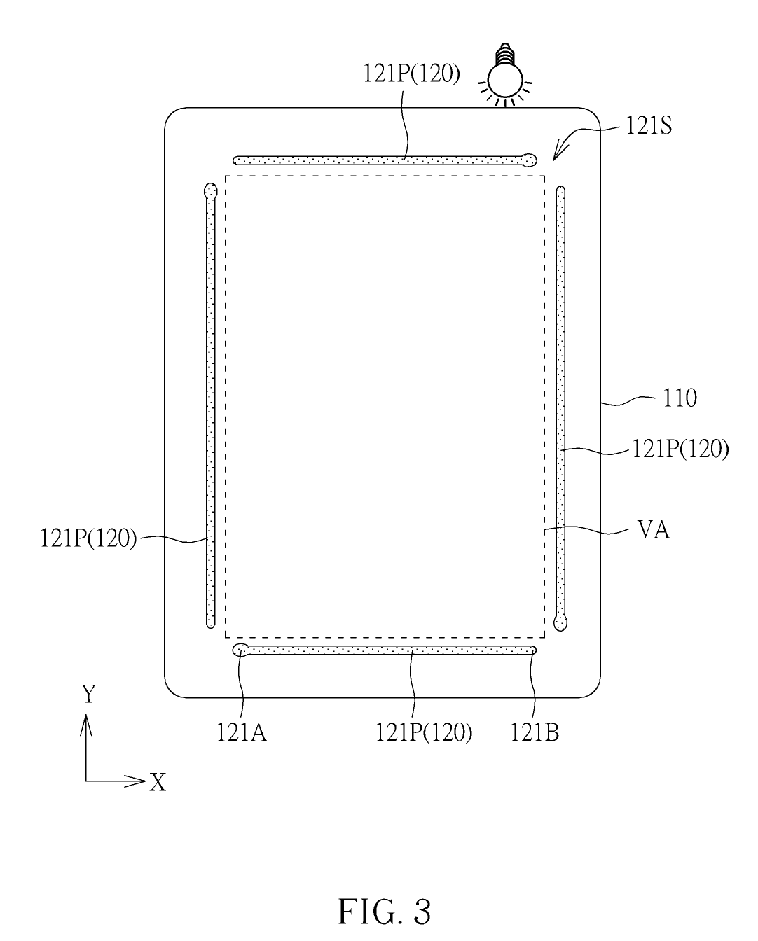

Please refer to FIG. 1, FIG. 2, FIG. 3, FIG. 4 and FIG. 5. FIG. 1 is a schematic flow chart illustrating a lamination method of an electronic device according to a first embodiment of the present invention. FIG. 2, FIG. 3, FIG. 4 and FIG. 5 are schematic diagrams illustrating the lamination method of the electronic device in this embodiment. Please note that the figures are only for illustration and the figures may not be to scale. The scale maybe further modified according to different design considerations. As shown in FIG. 1 and FIG. 2, the lamination method of the electronic device in this embodiment includes the following steps. A first component 110 is provided first. The first component 110 may include a display panel module, a touch panel, a glass substrate, a cover lens, a plastic substrate, a flexible plastic substrate, a thin glass substrate, a substrate of a display device or other components required to be bound to other components in the electronic device. The display panel module mentioned above includes a liquid crystal display (LCD) module, an organic light emitting display (OLED) module, or an electro-phoretic display (EPD) module. The cover lens may be plastic or a strengthened glass. A decoration layer and a touch unit may be selectively disposed on one side of the cover lens. The decoration layer is disposed on at least one side of the cover lens so as to cover a portion of traces of the touch unit. Subsequently, in step S110, a first liquid optical clear adhesive 120 is formed on the first component 110. The first liquid optical clear adhesive 120 includes an acrylic adhesive, a silicon adhesive or other appropriate liquid optical clear adhesives. Specifically, when the first component 110 in this embodiment is a display panel module or a touch panel, the first component 110 may have a visible region VA, and the first liquid optical clear adhesive 120 formed on the first component 110 may include a plurality of first liquid optical clear adhesive patterns 121 surrounding the visible region VA, but not limited thereto. In other embodiments of the present invention, the first liquid optical clear adhesive patterns 121 may also be formed on a periphery of the visible region VA, formed in the visible region VA, or formed to partially overlap the visible region VA. Each of the first liquid optical clear adhesive patterns 121 may be formed by a glue dispenser, such as a nozzle type glue dispenser or a gear wheel type glue dispenser, and each of the first liquid optical clear adhesive patterns 121 has a first end 121A and a second end 121B opposite to the first end 121A accordingly. The first end 121A is the start point of glue dispensing, and a width of the first end 121A is wider than a width of the second end 121B. The first liquid optical clear adhesive patterns 121 may be sequentially formed by the glue dispenser and surround the peripheral region of the first component 110, and the first end 121A of one first liquid optical clear adhesive pattern 121 is adjacent to the second end 121B of another first liquid optical clear adhesive pattern 121 preferably, but not limited thereto. As shown in FIG. 2, the first liquid optical clear adhesive patterns 121 may be formed clockwise or counterclockwise by glue dispensing. The operations of the glue dispenser may be simplified, the dispensing process may be accelerated, and the efficiency may be enhanced accordingly. In other embodiments of the present invention, the alignment condition of the first optical clear adhesive patterns 121 may be further modified according to different designs of the glue dispensers or/and different predetermined laminating regions of the first component 110. For example, in this embodiment, the visible region VA of the first component 110 maybe a rectangle, and the first liquid optical clear adhesive 120 may include four first liquid optical clear adhesive patterns 121 formed on four sides of the first component 110 respectively. In other words, some of the first liquid optical clear adhesive patterns 121 may extend along a first direction X, some of the first liquid optical clear adhesive patterns 121 may extend along a second direction Y, and two adjacent first liquid optical clear adhesive patterns 121 extend along different directions. The first direction X is substantially perpendicular to the second direction Y, but not limited thereto. Additionally, a gap 121S exists between two adjacent spacing structures 121, and other excess liquid optical clear adhesives (not shown) formed in the visible region VA may overflow via the gap 121S.

As shown in FIG. 1 and FIG. 3, in step S120, the first liquid optical clear adhesive 120 is then treated by a pre-curing treatment so as to form a plurality of spacing structures 121P. The spacing structures 121P are semi-solidified at this point preferably for rework purposes, but not limited thereto. The pre-curing treatment mentioned above may include a thermal curing treatment, an ultraviolet curing treatment or other appropriate curing treatments suitable for the material properties of the first liquid optical clear adhesive 120. As shown in FIG. 3, an ultraviolet light source may irradiate the first liquid optical clear adhesive 120 from a lateral side or an upper side for pre-curing the first liquid optical clear adhesive 120, but not limited thereto.

As shown in FIG. 1 and FIG. 4, in step S130, a second liquid optical clear adhesive 130 is then formed on the first component 110. The pattern of the second liquid optical clear adhesive 130 formed on the first component 110 may be modified according to the design of the glue amount and the structure of the first component 110. The second liquid optical clear adhesive 130 may include an acrylic adhesive, a silicon adhesive or other appropriate liquid optical clear adhesives. The first liquid optical clear adhesive 120 and the second liquid optical clear adhesive 130 are transparent after curing preferably, so as to avoid influencing the appearance and display effects. It is worth noting that the spacing structures 121P may be used to maintain a required height of the second liquid optical clear adhesive 130, and a height of the spacing structure 121P is larger than a laminating thickness. For example, a height of each spacing structure 121P along a vertical projective direction Z perpendicular to the first component 110 is substantially higher than or equal to 0.1 millimeter and lower than or equal to 10 millimeters, but not limited thereto.

As shown in FIG. 1 and FIG. 5, in step S140, a second component 140 is bound to the first component 110. Subsequently, in step S150, the second liquid optical clear adhesive 130 is treated by a pre-curing treatment so as to form an optical clear adhesive layer 130P. The optical clear adhesive layer 130P is semi-solidified at this point preferably for rework purposes, but not limited thereto. The pre-curing treatment mentioned above may include a thermal curing treatment, an ultraviolet curing treatment or other appropriate curing treatments suitable for the material properties of the second liquid optical clear adhesive 130. The spacing structures 121P and the optical clear adhesive layer 130P are transparent preferably, but not limited thereto. It is optional to clean the excess amount of the second liquid optical clear adhesive 130 in step S160. It is worth noting that the amount of the second liquid optical clear adhesive 130 formed on the first component 110 is generally excess in order to avoid the shortage issue of the second liquid optical clear adhesive 130. The excess second liquid optical clear adhesive 130 may overflow via the gaps 121S between the spacing structures 121P after the first component 110 and the second component 140 are combined by pressing, and the laminating condition will not be influenced by the excess second liquid optical clear adhesive 130 accordingly. In step S170, The first liquid optical clear adhesive 120 and the second liquid optical clear adhesive 130 may then be treated by a main curing treatment so as to form an electronic device 100 shown in FIG. 5. The main curing treatment mentioned above may include a thermal curing treatment, an ultraviolet curing treatment or other appropriate curing treatments. For example, an ultraviolet light source may irradiate the first liquid optical clear adhesive 120 and the second liquid optical clear adhesive 130 from a lateral side or an upper side for main curing the first liquid optical clear adhesive 120 and the second liquid optical clear adhesive 130, but not limited thereto. Additionally, curing conditions may include the curing time or the curing approaches, such as irradiation from the lateral side or from the upper side. If the curing conditions of the second liquid optical clear adhesive 130 are different from the curing conditions of the first liquid optical clear adhesive 120, a refractive index of the optical clear adhesive layer 130p may become different from a refractive index of the spacing structures 121P. It is worth noting that the second component 140 in this embodiment may also include a display panel module, a touch panel, a glass substrate, a cover lens, a plastic substrate, a flexible plastic substrate, a thin glass substrate, a substrate of a display device or other components suitable to be combined with the first component 110. The display panel module mentioned above includes a liquid crystal display module, an organic light emitting display module, or an electro-phoretic display module. For example, when the first component 110 is a touch panel and the second component 140 is a display panel module, the electronic device 100 may be regarded as a touch display device. Specifically, when the display panel module is a liquid crystal display panel module, the spacing structures 121P made of the first liquid optical clear adhesive 120 is formed between a polarizing film (not shown) of the liquid crystal display panel module and the touch panel. A distance between each spacing structure 121P and an edge of the polarizing film is larger than 0.01 millimeter. The spacing structures 121P made of the first liquid optical clear adhesive 120 may be disposed on at least two sides of one surface of the polarizing film. For example, as shown in FIG. 5, the first liquid optical clear adhesive 120 (the spacing structures 121P) at the left side and the right side may be kept, and the first liquid optical clear adhesive 120 at the upper side and the lower side may be omitted. Similarly, when the display panel module is an organic light emitting display module, the spacing structures 121P may be selectively disposed on an encapsulation substrate or a polarizing film (not shown). When the first component 110 is a cover lens and the second component 140 is a substrate with touch units disposed on, the electronic device 100 may also be regarded as a touch device. In other words, the lamination method in the present invention is suitable for components to be combined in the electronic device. The liquid optical clear adhesives are employed in the lamination method of the present invention, height differences on rugged surfaces of the components to be bound may be filled with the optical clear adhesive 130P more easily. The laminating condition may be improved, and the appearance quality and electrical operations of the electronic device 100 may be enhanced accordingly.

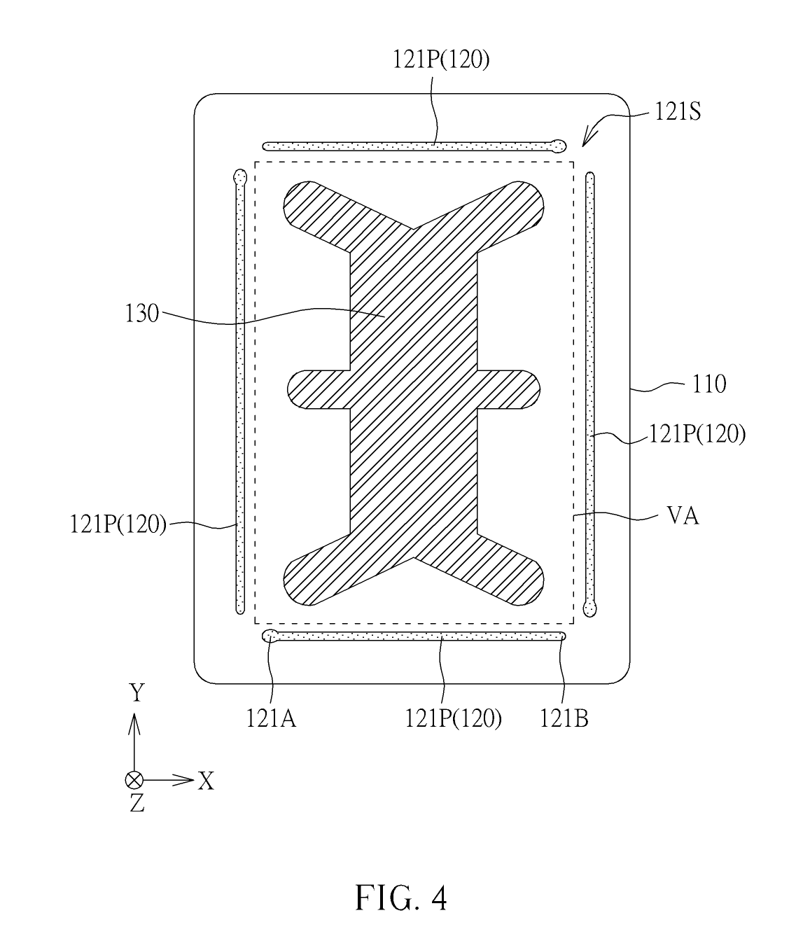

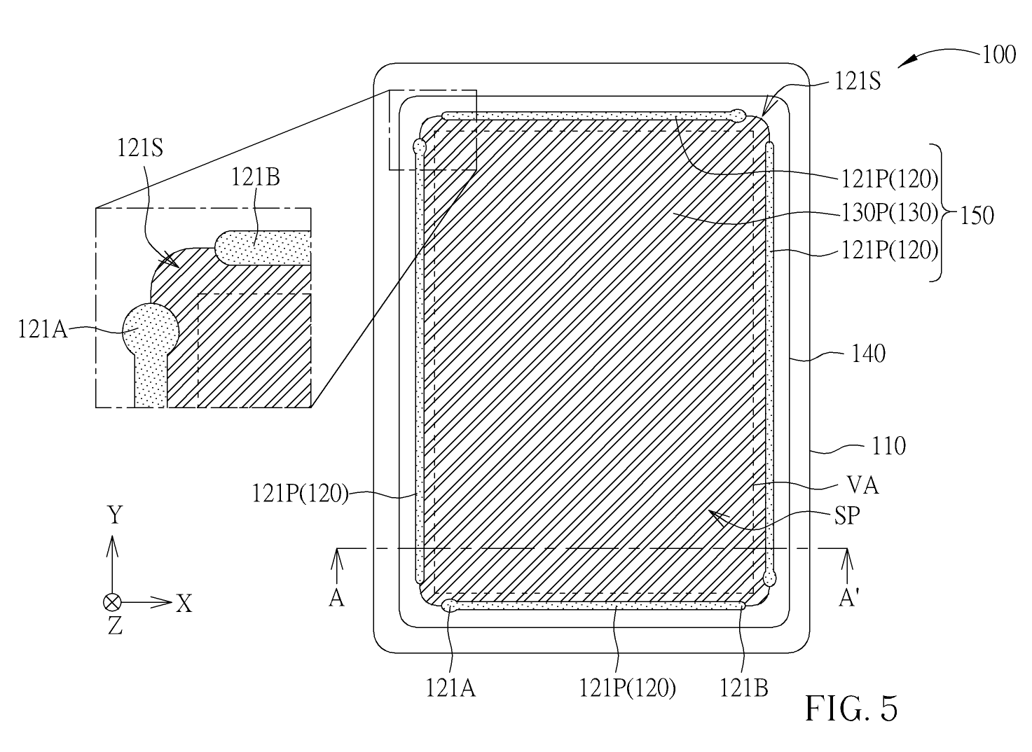

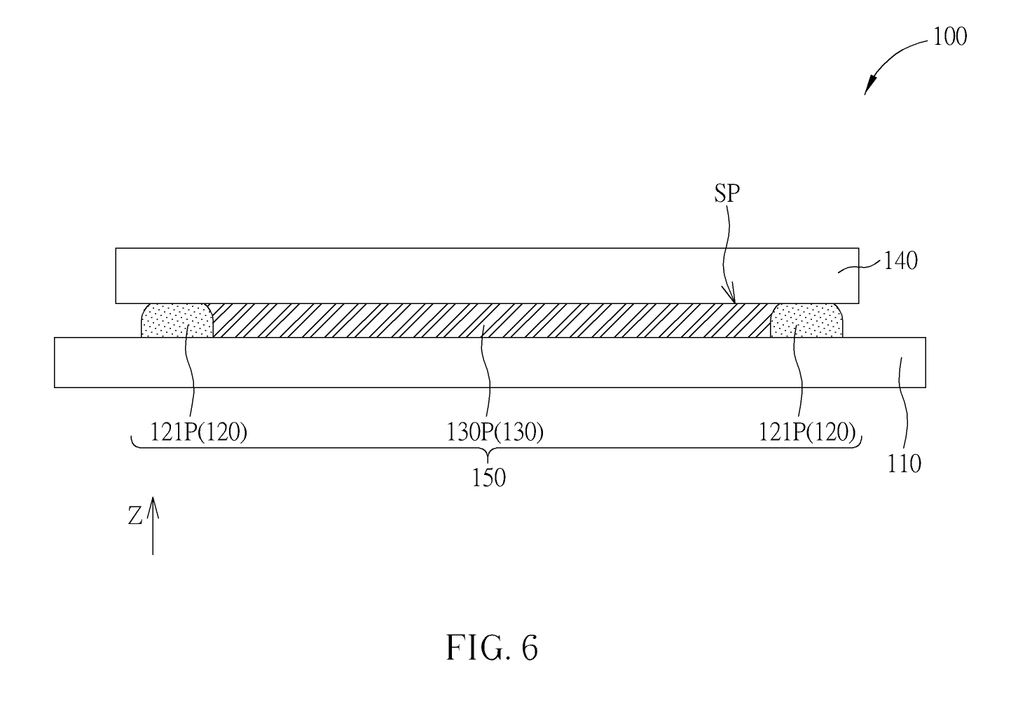

Please refer to FIG. 5 and FIG. 6. FIG. 5 is a schematic diagram illustrating the electronic device according to the first embodiment of the present invention. FIG. 6 is a schematic cross-sectional diagram taken along a line A-A′ in FIG. 5. As shown in FIG. 5 and FIG. 6, the electronic device 100 in this embodiment includes the first component 110, the second component 140 and a combining unit 150. The second component 140 is disposed correspondingly to the first component 110. The combining unit 150 is disposed between the first component 110 and the second component 140 so as to combine the first component 110 with the second component 140. The combining unit 150 includes the optical clear adhesive layer 130P and a plurality of the spacing structures 121P. The spacing structures 121P are aligned to define an accommodation space SP between the first component 110 and the second component 140. The optical clear adhesive layer 130P is at least partially disposed in the accommodation space SP. The spacing structures 121P surround the accommodation space SP and the optical clear adhesive layer 130P. Each of the spacing structures 121P has a first end 121A and a second end 121B opposite to the first end. A width of the first end 121A is wider than a width of the second end 121B. The spacing structures 121P are formed by solidifying the first liquid optical clear adhesive 120, and the optical clear adhesive layer 130P is formed by solidify the second liquid optical clear adhesive 130. In this embodiment, the first end 121A of each spacing structure 121P is disposed adjacently to one second end 121B of another spacing structure 121P, but not limited thereto. The gap 121S exists between two adjacent spacing structures 121P. Additionally, in this embodiment, at least two of the spacing structures 121P disposed adjacently to each other extend along different directions, but the present invention is not limited to this. The material properties of each part in the electronic device 100 have been detailed in the lamination method described above and will not be redundantly described. It is worth noting that the size of the first component 110 maybe equal to or different from the size of the second component 140. The optical clear adhesive layer 130P is surrounded by the spacing structures 121P, and the second liquid optical clear adhesive 130 used to form the optical clear adhesive layer 130P preferably has relatively lower viscosity so as to cover the height differences on the components more easily.

The following description will detail the different embodiments of the present invention. To simplify the description, identical components in each of the following embodiments are marked with identical symbols. For making it easier to understand the differences between the embodiments, the following description will detail the dissimilarities among different embodiments and the identical features will not be redundantly described.

Please refer to FIG. 7. FIG. 7 is a schematic diagram illustrating an electronic device 200 according to a second embodiment of the present invention. As shown in FIG. 7, the difference between the electronic device 200 in this embodiment and the electronic device in the first embodiment is that, in the electronic device 200, at least apart of the optical clear adhesive layer 130P extends outward from the accommodation space SP via the gaps 121S. The excess optical clear adhesive layer 130P may overflow in this way and may be removed without influencing the appearance and quality of the electronic device 200.

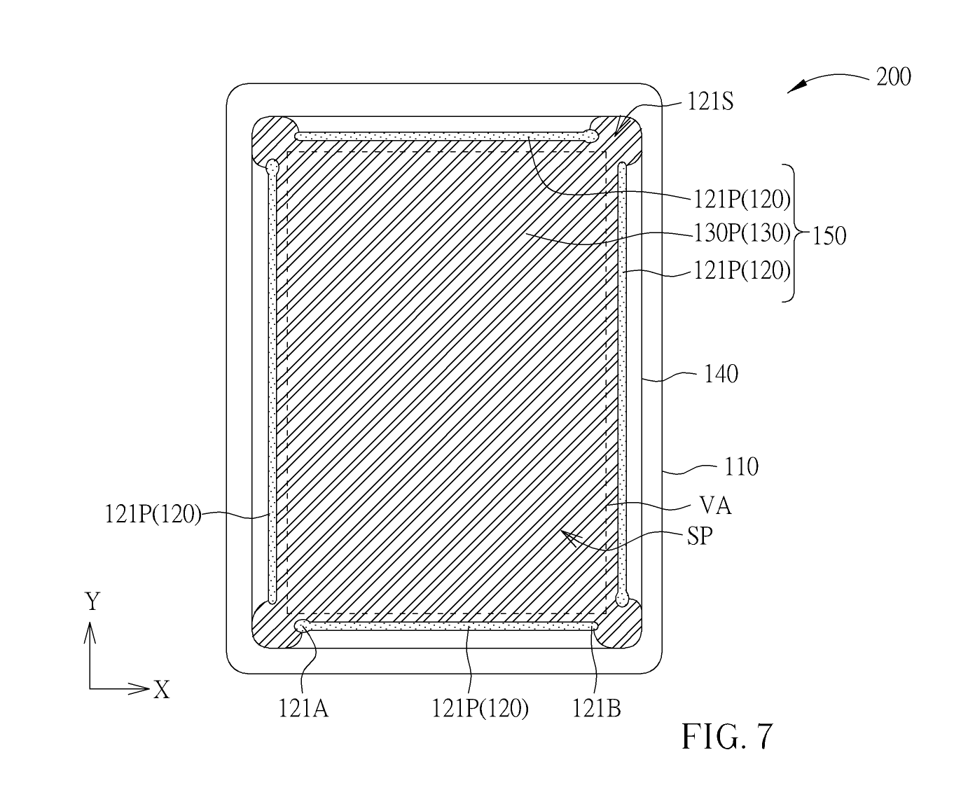

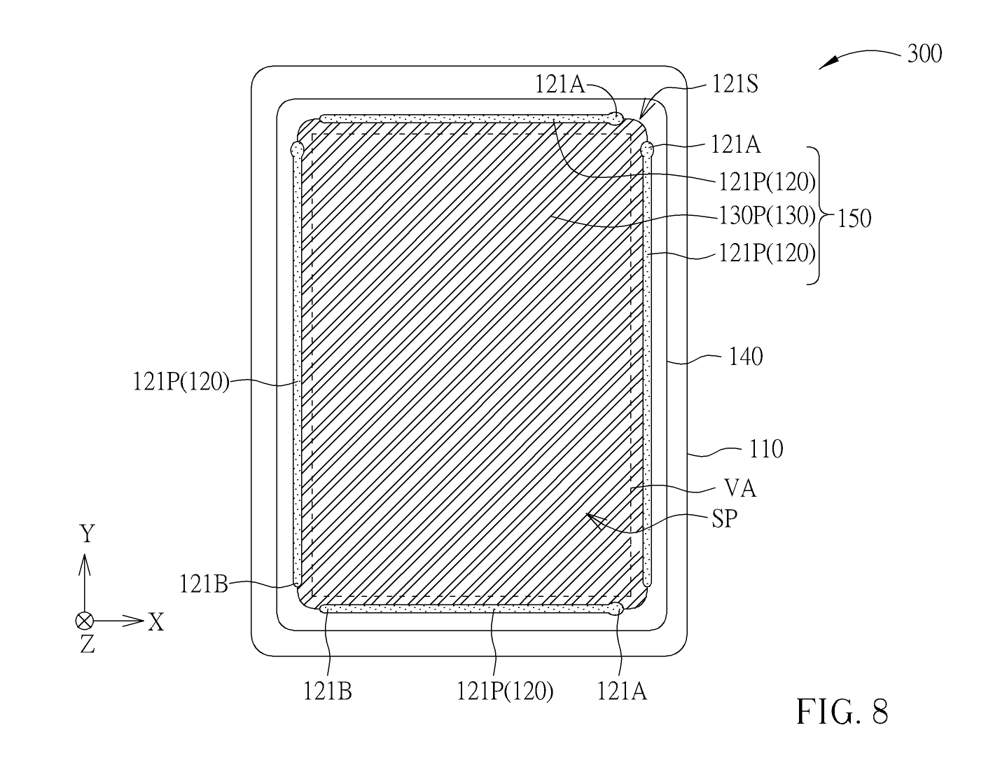

Please refer to FIG. 8. FIG. 8 is a schematic diagram illustrating an electronic device 300 according to a third embodiment of the present invention. As shown in FIG. 8, the difference between the electronic device 300 in this embodiment and the electronic device in the first embodiment is that, in the electronic device 300, the first end 121A of at least one spacing structure 121P is adjacent to another first end 121A of another spacing structure 121P, and the second end 121B of at least one spacing structure 121P is adjacent to another second end 121B of another spacing structure 121P. The allocation condition of the spacing structures 121P is mainly decided by the design of the glue dispenser. For instance, when there are two nozzles designed in the glue dispenser, the spacing structures 121P at the upper side and the lower side in FIG. 8 may be formed simultaneously, and/ or the spacing structures 121P at the left side and the right side in FIG. 8 may be formed simultaneously. The allocation conduction of the first ends 121A and the second ends 121B of the spacing structures 121P may be formed accordingly.

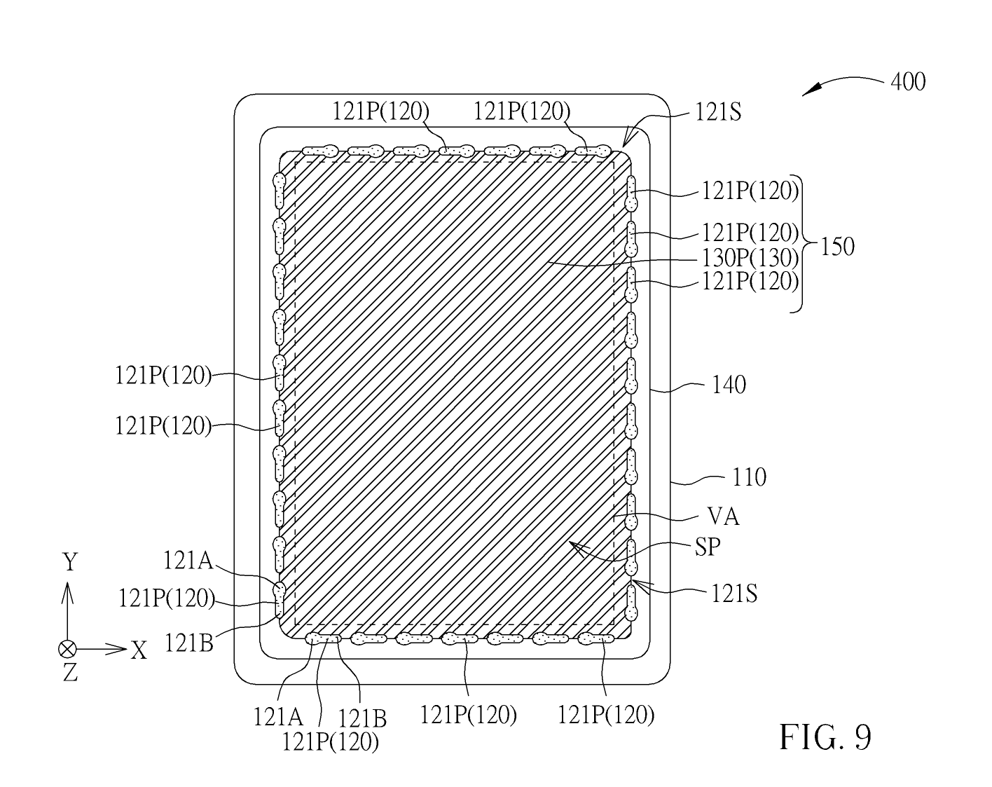

Please refer to FIG. 9. FIG. 9 is a schematic diagram illustrating an electronic device 400 according to a fourth embodiment of the present invention. As shown in FIG. 9, the difference between the electronic device 400 in this embodiment and the electronic device in the first embodiment is that, in the electronic device 400 of this embodiment, at least two of the spacing structures 121P disposed adjacently to each other extend along one identical direction. Specifically, some of the spacing structures 121P may be disposed at one identical side of the visible region VA, and the amount of the gaps 121S may be increased. The second liquid optical clear adhesive 130 may reflow by impressing more quickly in the lamination process, and gaseous materials may be exhausted more quickly too.

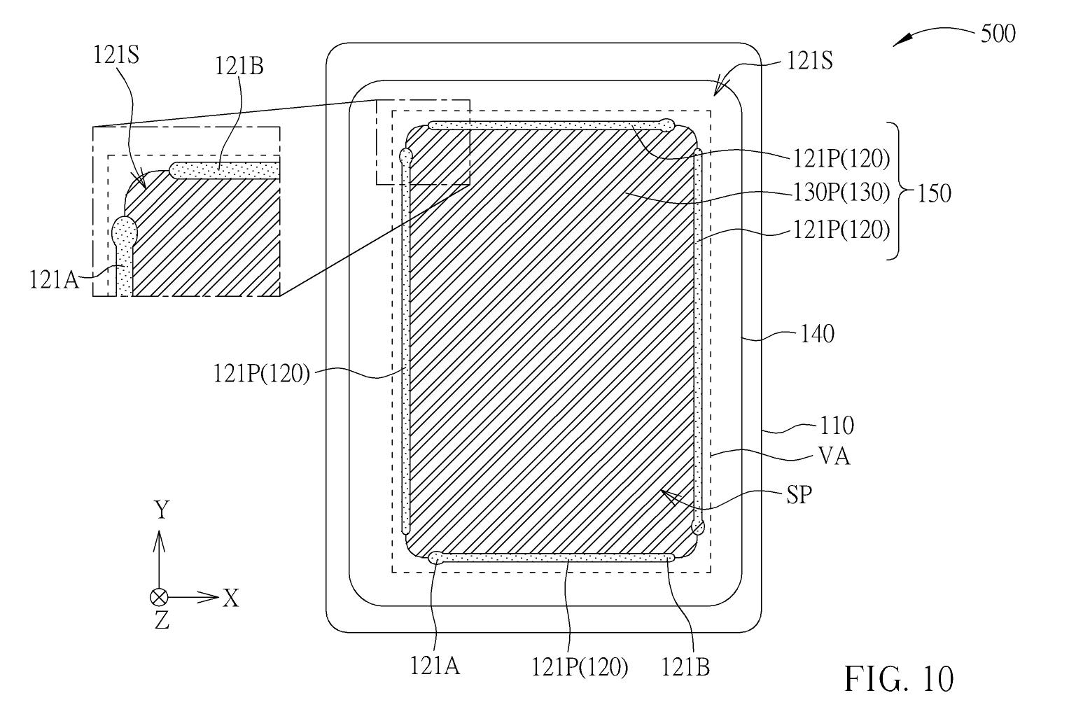

Please refer to FIG. 10. FIG. 10 is a schematic diagram illustrating an electronic device 500 according to a fifth embodiment of the present invention. As shown in FIG. 10, the difference between the electronic device 500 in this embodiment and the electronic device in the first embodiment is that the spacing structures 121P in this embodiment are disposed in the visible region VA. The optical clear adhesive layer 130P may be totally disposed within the visible region VA or partially disposed outside the visible region VA according to different process conditions. The curing approaches of the first liquid optical clear adhesive 120, which is used to form the spacing structures 121P, are more flexible because the spacing structures 121P are disposed in the visible region VA. It is worth noting that the allocation of the spacing structures 121P in this embodiment may also be applied to other embodiments of the present invention.

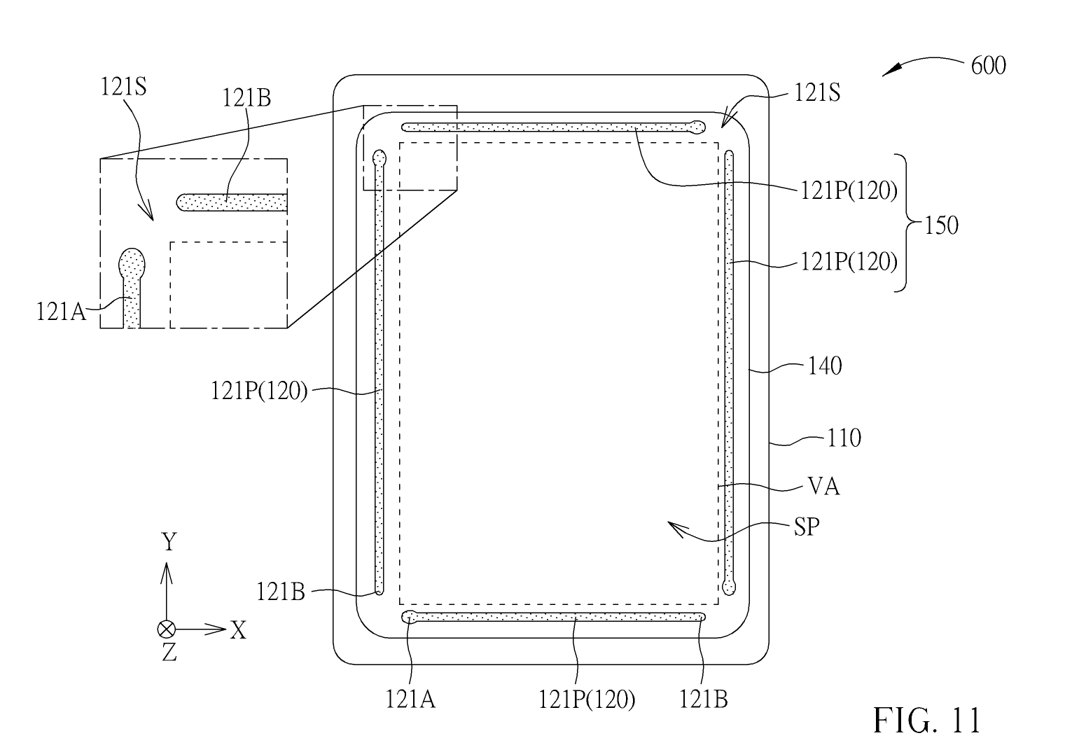

Please refer to FIG. 11. FIG. 11 is a schematic diagram illustrating an electronic device 600 according to a sixth embodiment of the present invention. As shown in FIG. 11, the difference between the electronic device 600 in this embodiment and the electronic device in the first embodiment is that the combining unit 150 in this embodiment merely includes the spacing structures 121P without the optical clear adhesive layer mentioned in other embodiments. In other words, the first component 110 and the second component 140 of the electronic device 600 in this embodiment may be combined by the spacing structures 121P only. It is worth noting that the optical clear adhesive layer in the embodiments mentioned above may also be removed according to other design considerations, and the first component 110 and the second component 140 may be combined by the spacing structures 121P only.

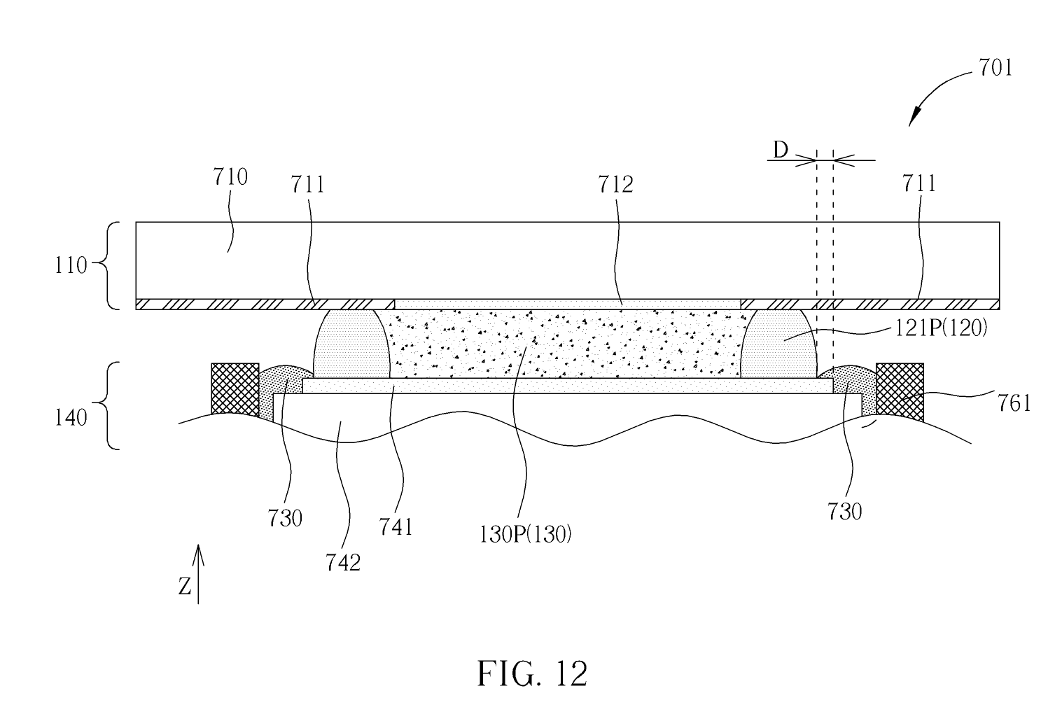

Please refer to FIG. 12. FIG. 12 is a schematic diagram illustrating an electronic device 701 according to a seventh embodiment of the present invention. As shown in FIG. 12, the difference between the electronic device 701 in this embodiment and the electronic device in the first embodiment is that the first component 110 in this embodiment is a touch panel, and the second component 140 is a display panel module including a polarizing film 741 and a display substrate 742. The polarizing film 741 is disposed on the display substrate 742. The spacing structures 121P are disposed on at least two side of one surface of the polarizing film 741, and a distance D between each spacing structure 121P and an edge of the polarizing film 741 is larger than 0.01 millimeter preferably. In addition, the first component 110 of this embodiment includes a cover lens 710, a decoration layer 711 and a touch unit 712. The decoration layer 711 and the touch unit 712 are disposed on one side of the cover lens 710. The second component 140 may further include a protection sealant 730 and a first outer frame 761. The first outer frame 761 surrounds the display substrate 742, and the protection sealant 730 is at least partially disposed between the first outer frame 761 and the display substrate 742. The protection sealant 730 surrounds the display substrate 742 for generating a protection effect, but not limited thereto. In this embodiment, the first liquid optical clear adhesive 120 is preferably formed on the polarizing film 741 before the step of combining the first component 110 and the second component 140, but the present invention is not limited to this. In other embodiments of the present invention, the first liquid optical clear adhesive 120 may also be formed on the first component 110 before the step of combining the first component 110 and the second component 140.

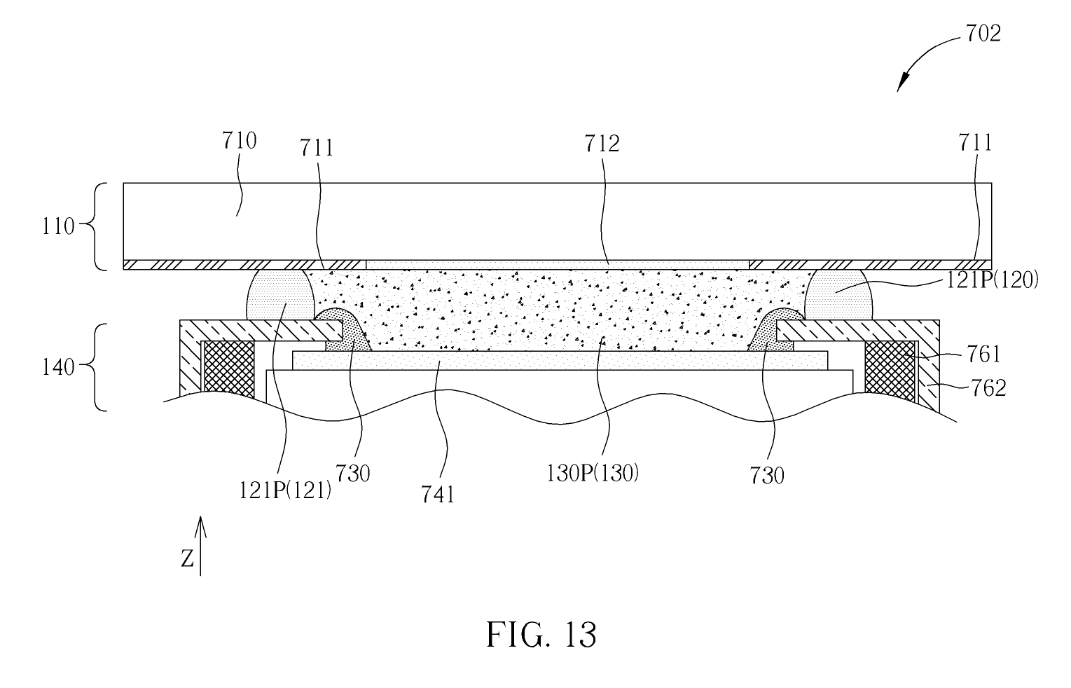

Please refer to FIG. 13. FIG. 13 is a schematic diagram illustrating an electronic device 702 according to an eighth embodiment of the present invention. As shown in FIG. 13, the difference between the electronic device 702 in this embodiment and the electronic device in the seventh embodiment is that the second component 140 in this embodiment is a display panel module further including a second outer frame 762. The second outer frame 762 surrounds the first outer frame 761, and the spacing structures 121P are disposed on the second frame 762. The protection sealant 730 is at least partially disposed between the second outer frame 762 and the polarizing film 741 so as to keep the optical clear adhesive layer 130P from flowing into the spacing between the first outer frame 761 and the display substrate 742. In this embodiment, the first liquid optical clear adhesive 120 is preferably formed on the first outer frame 761 before the step of combining the first component 110 and the second component 140, but the present invention is not limited to this. In other embodiments of the present invention, the first liquid optical clear adhesive 120 may also be formed on the first component 110 before the step of combining the first component 110 and the second component 140.

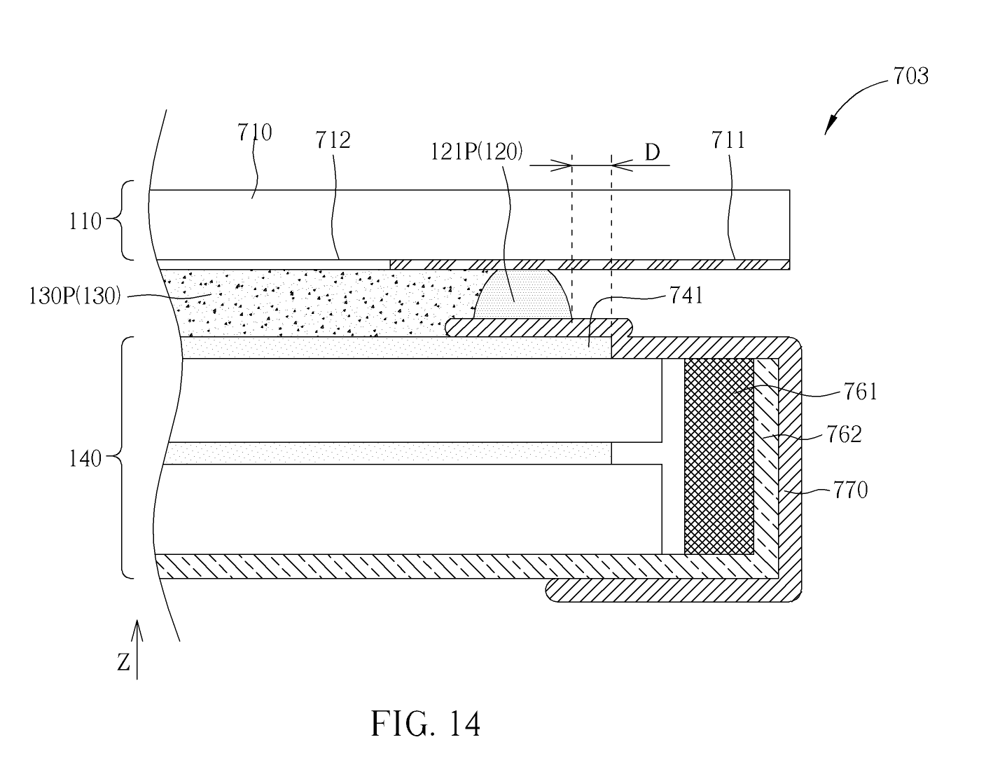

Please refer to FIG. 14. FIG. 14 is a schematic diagram illustrating an electronic device 703 according to a ninth embodiment of the present invention. As shown in FIG. 14, the difference between the electronic device 703 in this embodiment and the electronic device in the eighth embodiment is that the second component 140 in this embodiment is a display panel module further including an anti-permeation tape 770 at least partially covering the polarizing film 741, the display substrate 742, the first outer frame 761 and the second outer frame 762. The spacing structures 121P are disposed on the anti-permeation tape 770 so as to keep the optical clear adhesive 130P from leaking out. Additionally, the distance D between each spacing structure 121P and the edge of the polarizing film 741 is larger than 0.01 millimeter preferably, but not limited thereto. In this embodiment, the first liquid optical clear adhesive 120 is preferably formed on the anti-permeation tape 770 before the step of combining the first component 110 and the second component 140, but the present invention is not limited to this. In other embodiments of the present invention, the first liquid optical clear adhesive 120 may also be formed on the first component 110 before the step of combining the first component 110 and the second component 140.

To summarize the above descriptions, in the electronic device of the present invention, a combining unit formed by the liquid optical clear adhesive is used to combine two components in the electronic device. The improved filling performance of the optical clear adhesive layer is employed to improve the laminating condition. The appearance and electrical qualities of the electronic device may be enhanced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a first component;
a second component, disposed correspondingly to the first component; and
a combining unit, disposed between the first component and the second component so as to combine the first component with the second component, the combining unit comprising a plurality of spacing structures, configured to define an accommodation space between the first component and the second component, wherein each of the spacing structures has a first end and a second end opposite to the first end, and a width of the first end is wider than a width of the second end.

2. The electronic device of claim 1, wherein the first end of each spacing structure is disposed adjacently to one second end of another spacing structure.

3. The electronic device of claim 1, wherein a gap exists between two adjacent spacing structures.

4. The electronic device of claim 1, wherein the combining unit further comprises an optical clear adhesive layer, at least partially disposed in the accommodation space, and the spacing structures surround the optical clear adhesive layer.

5. The electronic device of claim 4, wherein a gap exists between two adjacent spacing structures, and at least a part of the optical clear adhesive layer extends outward from the accommodation space via the gap.

6. The electronic device of claim 4, wherein the spacing structures are formed by solidifying a first liquid optical clear adhesive, and the optical clear adhesive layer is formed by solidify a second liquid optical clear adhesive.

7. The electronic device of claim 4, wherein a refractive index of the optical clear adhesive layer is different from a refractive index of the spacing structures.

8. The electronic device of claim 1, wherein at least two of the spacing structures disposed adjacently to each other extend along different directions.

9. The electronic device of claim 1, wherein at least two of the spacing structures disposed adjacently to each other extend along one identical direction.

10. The electronic device of claim 1, wherein at least one of the first component and the second component comprises a display panel module or a touch panel.

11. The electronic device of claim 10, wherein the display panel module comprises a polarizing film, the spacing structures are disposed on at least two sides of one surface of the polarizing film, and a distance between each spacing structure and an edge of the polarizing film is larger than 0.01 millimeter.

12. The electronic device of claim 10, wherein the display panel module comprises a polarizing film, a display substrate and a first outer frame, the polarizing film is disposed on the display substrate, and the first outer frame surrounds the display substrate.

13. The electronic device of claim 12, wherein the display panel module further comprises a protection sealant, at least partially disposed between the first outer frame and the display substrate, and the protection sealant surrounds the display substrate.

14. The electronic device of claim 12, wherein the display panel module further comprises:
a second outer frame, surrounding the first outer frame; and
a protection sealant, at least partially disposed between the second outer frame and the polarizing film, wherein the spacing structures are disposed on the second frame.

15. The electronic device of claim 12, wherein the display panel module further comprises an anti-permeation tape at least partially covering the polarizing film, and the spacing structures are disposed on the anti-permeation tape.

16. The electronic device of claim 1, wherein the first component is a touch panel, the second component is a display panel module, and the display panel module includes a liquid crystal display (LCD) module, an organic light emitting display (OLED) module, or an electro-phoretic display (EPD) module.

17. The electronic device of claim 1, wherein the first component or/and the second component includes a glass substrate, a cover lens, a plastic substrate, a flexible plastic substrate, a thin glass substrate or a substrate of a display device.

18. The electronic device of claim 13, wherein a decoration layer and a touch unit are disposed on one side of the cover lens.

19. The electronic device of claim 1, wherein a height of each spacing structure is higher than or equal to 0.1 millimeter and lower than or equal to 10 millimeters.
